(19) United States
(12) Patent Application Publication
(10) Pub. No.: US 2014/0006047 A1
(43) Pub. Date: Jan. 2, 2014

(54) MEDICAL RECORD RETRIEVAL SYSTEM BASED ON SENSOR INFORMATION AND A METHOD OF OPERATION THEREOF

(71) Applicants: Sheshadri Amathnadu, Santa Clara, CA (US); Adam Odessky, San Francisco, CA (US)

(72) Inventors: Sheshadri Amathnadu, Santa Clara, CA (US); Adam Odessky, San Francisco, CA (US)

(73) Assignee: FRANCE TELECOM, Paris (FR)

(21) Appl. No.: 13/997,456

(22) PCT Filed: Dec. 20, 2011
(86) PCT No.: PCT/IB11/03336

§ 371 Date: Sep. 19, 2013

Related U.S. Application Data
(60) Provisional application No. 61/427,031, filed on Dec. 23, 2010.

(51) Int. Cl. G06F 19/00

(52) U.S. Cl. CPC G06F 19/322
USPC 705/2

(57) ABSTRACT

A method of retrieving electronic medical record (EMR) information from an EMR memory having electronic medical records for a plurality of persons. The method is controlled by one or more controllers and may include one or more acts of: obtaining sensor information corresponding to one or more physiologic indications of a user; identifying a medical condition of the user based upon the sensor information; filtering electronic medical record (EMR) information of the user based upon the identified medical condition of the user, the EMR including a plurality of electronic medical records of the user; and providing the filtered EMR of the user. The method may also select one or more addresses to which to transmit the filtered EMR and transmit the filtered EMR to the selected addresses.

### CROSS-REFERENCE TO RELATED APPLICATIONS

This Application is a Section 371 National Stage Application of International Application No. PCT/IB2011/003336, filed Dec. 20, 2011, which is incorporated by reference in its entirety and published as WO 2012/085687 on Jun. 28, 2012, in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE PRESENT SYSTEM

The present system relates generally to a technique for obtaining health information related to a user, and more specifically to a health record access system which retrieves electronic medical records (EMR) related to the user based upon determined medical conditions.

### BACKGROUND OF THE PRESENT SYSTEM

As mobile stations (MSs) such as smart phones and the like evolve, MSs have begun to incorporate applications which use sensory information from sensors coupled to the MSs such as fingerprint data to gain access to the MS. These applications do not provide access to a filtered EMR of a user.

### SUMMARY OF THE PRESENT SYSTEM

The present system discloses a system, method, apparatus, user interface (UI), and computer program portion (hereinafter each of which may be referred to as system unless the context indicates otherwise) suitable to obtain, process, and/or render information related to the user (e.g., a patient) such as EMR. In accordance with an embodiment of the present system, there is disclosed a method of retrieving electronic medical record (EMR) information, the method controlled by one or more controllers and including acts of: obtaining sensor information corresponding to one or more physiologic indications of a user; identifying a medical condition of the user based upon the sensor information; filtering electronic medical record (EMR) information of the user based upon the identified medical condition of the user, the EMR including a plurality of electronic medical records of the user; and/or providing the filtered EMR of the user.

The method may further include an act of updating the EMR in accordance with the sensor information. Moreover, the method may further include acts of: determining an address of one or more recipients for the filtered EMR; and/or transmitting the filtered is EMR to the one or more recipients.

It is also envisioned that the method may further include an act of obtaining other sensor information related to one or more of image information, location information, and environmental information. Moreover, the method may include an act of determining an appropriate action in accordance with the other sensor information and one or more of the determined medical condition and the filtered EMR.

It is further envisioned that the method may include acts of: identifying the user based upon the image information; and/or accessing the EMR in accordance with the identification of the user.

In another aspect of the present system, there is disclosed a system to retrieve electronic medical record (EMR) information of a user. The system may include: a processor portion which may: obtain sensor information corresponding to one or more physiologic indications of a user; identify a medical condition of the user based upon the sensor information; filter electronic medical record (EMR) information of the user based upon the identified medical condition of the user, the EMR including a plurality of electronic medical records of the user; and/or provide the filtered EMR of the user.

The processing portion may further update the EMR in accordance with the sensor information. Further, the processing portion may: determine an address of one or more recipients for the filtered EMR; and/or transmit the filtered EMR to the one or more recipients.

It is further envisioned that the processing portion may obtain other sensor information related to one or more of image information, location information, and environmental information from corresponding sensors; and/or determine an appropriate action (or actions) such as recommending a healthier alternative, etc., in accordance with the other sensor information and one or more of the determined medical condition and the filtered EMR; and informs the user of the appropriate action. It is envisioned that the processing portion may further: identify the user based upon the image information; and/or access the EMR in accordance with the identification of the user.

In accordance with embodiments of the present system, there is disclosed a computer program stored on a non-transitory computer readable memory medium, the computer program configured to retrieve electronic medical record (EMR) information, the computer program may include a program portion configured to: obtain sensor information corresponding to one or more physiologic indications of a user; identify a medical condition of the user based upon the sensor information; filter electronic medical record (EMR) information of the user based upon the identified medical condition of the user, the EMR including a plurality of electronic medical records of the user; and/or provide the filtered EMR of the user.

It is also envisioned that the program portion may be configured to update the EMR in accordance with the sensor information. It is also envisioned that the program portion may be further configured to: determine an address of one or more recipients for the filtered EMR; and/or transmit the filtered EMR to the one or more recipients.

Further, the program portion may be further configured to obtain other sensor information related to one or more of image information, location information, and environmental information. It is also envisioned that the program portion may be configured to determine an appropriate action in accordance with the other sensor information and one or more of the determined medical condition and the filtered EMR, and informs the user of the appropriate action.

Moreover, it is envisioned that the program portion may be further configured to: identify the user based upon the image information; and/or access the EMR in accordance with the identification of the user.

### BRIEF DESCRIPTION OF THE DRAWINGS

The present system is explained in further detail, and by way of example, with reference to the accompanying drawings wherein:

FIG. 1 shows a functional flow diagram that illustrates a process in accordance is with embodiments of the present system;

FIG. 2 shows a flow diagram that illustrates a process in accordance with embodiments of the present system;

FIG. 3 shows a flow diagram that illustrates a process in accordance with embodiments of the present system; and

FIG. 4 shows a portion of a system (e.g., peer, server, etc.) in accordance with embodiments of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, circuits, tools, techniques, and methods are omitted so as not to obscure the description of the present system. It should be expressly understood that the drawings are included for illustrative purposes and do not represent the scope of the present system. In the accompanying drawings, like reference numbers in different drawings may designate similar elements.

For purposes of simplifying a description of the present system, the term mobile station (MS) may refer to communication devices such as a personal computer (PC), a tablet computer (e.g., iPad™), a personal digital assistant (PDA), a mobile phone, a cellular phone, a smart phone (e.g., an iPhone™), a medical device (e.g., blood glucose sensor, etc.), and/or other device for communicating using wired and/or wireless transmission methods.

Further, the terms “operatively coupled,” “coupled,” and formatives thereof as utilized herein refer to a connection between devices and/or portions thereof that enables operation in accordance with the present system. For example, an operative coupling may include one or more of a wired connection and/or a wireless connection between two or more devices that enables a one and/or two-way communication path between the devices and/or portions thereof. For example, an operative coupling may include a wired and/or a wireless coupling to enable communication between a content server and one or more user devices. A further operative coupling, in accordance with the present system may include one or more couplings between two or more user devices, such as via a network source, such as the content server (e.g., an EMR database (db) server), in accordance with embodiments of the present system.

The term rendering and formatives thereof as utilized herein refer to providing content, such as digital media which may include, for example, EMR, image information, information generated and/or accessed by the present system, messages, status information, settings, audio information, audiovisual information, sensor information, etc., such that it may be perceived by at least one user sense, such as a sense of sight and/or a sense of hearing. For example, the present system may render a user interface (UI) on a display device so that it may be seen and interacted with by a user. Further, the present system may render audio visual content on both of a device that renders audible output (e.g., a speaker, such as a loudspeaker) and a device that renders visual output (e.g., a display). To simplify the following discussion, the term content and formatives thereof will be utilized and should be understood to include audio content, visual content (e.g., medical images), audio visual content (medical videos such as sonograms, etc.), textual content, and/or other content types, unless a particular content type is specifically intended, as may be readily appreciated. Further, the content may include, for example, EMR, etc.

The user interaction with and manipulation of the computer environment may be achieved using any of a variety of types of human-processor interface devices that are operationally coupled to a processor (e.g., a controller) or processors controlling the displayed environment. A common interface device for a user interface (UI), such as a graphical user interface (GUI), is a mouse, trackball, keyboard, touch-sensitive display, a pointing device (e.g., a pen), etc. For example, a mouse may be moved by a user in a planar workspace to move a visual object, such as a cursor, depicted on a two-dimensional display surface in a direct mapping between the position of the user manipulation and the depicted position of the cursor. This is typically known as position control, where the motion of the depicted object directly correlates to motion of the user manipulation. In accordance with embodiments of the present system, inputs may be received via a touch sensitive UI. Further, the present system may receive information from an image capture device (e.g., a camera, a video camera, etc.) operatively coupled to a processor (e.g., a controller) or processors controlling the displayed environment and process these inputs as virtual inputs. Accordingly, the system may translate images in which certain relationships, gestures, movements, etc. may be translated into corresponding inputs or position control.

An example of such a GUI in accordance with an embodiment of the present system is a GUI that may be provided by a computer program that may be invoked by the system or user, such as to enable a user to interact (e.g., provide commands, provide sensor data, etc.) with the system.

An EMR (electronic medical record), PHR (personal health record), PHR Extract and/or other type of medical summary, etc., is a computerized medical record which is organized (i.e., divided) per users (e.g., patients) and typically contains medical information (e.g., complete medical record) for each such user. The electronic record typically includes detailed information including clinical documents, lab reports, images (e.g., x-ray, CT scan, MRIs, etc.), trend data, monitoring data etc. Typically these records are created in an organization that delivers care, such as a hospital, doctors office, dentist office etc., although may also include records from non-medical facilities such as insurance offices etc. To simplify the following discussion, the term EMR will be utilized to include any such electronic data source that is organized and retrievable with regard to given users. In fact, EMR is actually made up of many individual records related to the patient. Discussions herein will utilize terms such as EMR portions to discuss a filtered retrieval of EMR in accordance with embodiments of the present system.

The problem with conventional EMR is that it may include a vast amount of information related to a patient, only some of which may be relevant for any given situation, medical condition, etc., to a professional (e.g. a practitioner such as a doctor, etc.) treating the user. Further, for privacy reasons, the user may not desire a given practitioner or other party to have access to the entire EMR of the user.

The EMR may be stored in a medical information memory (MIM) of the system. The MIM may be any suitable memory such as a local memory, a remote memory, and/or distributed memory (e.g., a surface area network (SAN), etc.). The system may include a retrieval portion for retrieving filtering EMR. In accordance with the an embodiment of the present system, the retrieval portion may obtain the filtered EMR related to an identified user and which may be filtered in accordance with one or more selected medical conditions (MCs) of the user. The filtered EMR may include only EMR of the user that is determined by the system to be related to the selected medical conditions of the user. The filtered EMR may then be provided to one or more MSs and/or may be rendered on a user interface (UI) of the system such as a display device, a speaker, etc. for use by, for example, a medical professional such as a doctor, a technician, a nurse, etc. The MCs may be defined by a user and/or system and be mapped to certain types of records in the EMR database. For example, a medical condition such as diabetes may be mapped to blood flow, blood glucose, and cardiovascular, neuropathic and/or retinopathic records in the EMR database, while a medical condition such as sleep apnea may be mapped to breathing records, sleeping records, etc. Further medical conditions, such as an allergy (e.g., to pollen) may be mapped to records related to external and internal sensing data (see, discussion further herein related to sensors), such as temperature around the patient, barometric pressure, pollen count, and other readings along with location and internal body data regarding current/previous pollen/allergy incidents, etc. The mapping may be predefined and/or may be mapped in real time by the system for example, by using intelligent processing methods such as neural networks, etc.

Accordingly, by providing filtered EMR related to a selected medical condition, a medical professional may quickly and conveniently scan relevant EMR quickly and conveniently which can save time and reduce health care costs. Further, patient privacy may be enhanced by providing filtered EMR which is related to a particular medical condition as opposed to providing all EMR regardless of whether they are related to a current medical condition. Accordingly, access to EMR which is not determined to be related to the determined medical condition may be prevented unless specifically requested by a user which is determined to be authorized to access the certain EMR.

Further, the system may include an index portion which may mine EMR of one or more users from one or more external memories (e.g., insurance databases, hospital database, doctor's database, national medical databases, etc.) and form corresponding EMR which may be indexed and/or stored in an EMR database of the system to enhance accessibility. However, it is also envisioned that the EMR may be mined in real time.

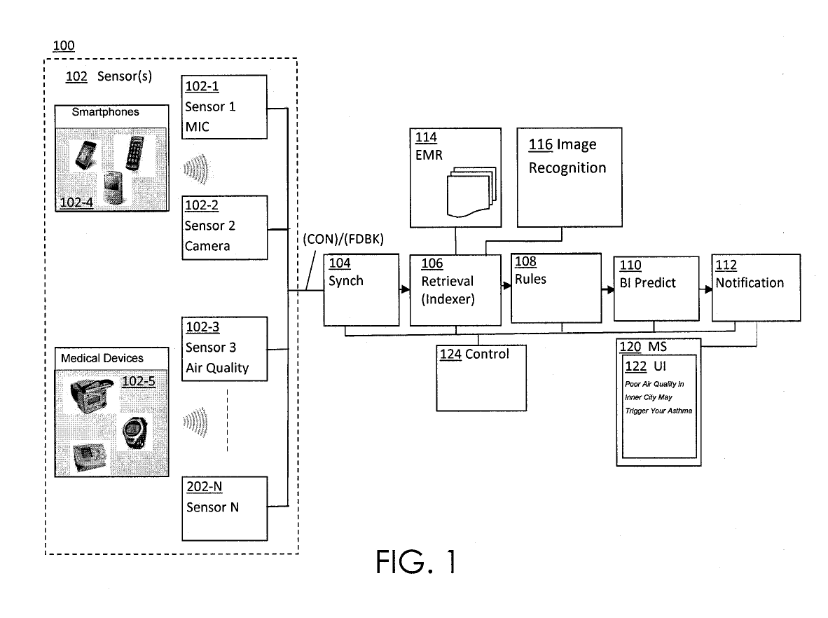

FIG. 1 shows a functional flow diagram 100 that illustrates a process in accordance with embodiments of the present system. The process may be performed using one or more computers communicating over a network. The process may include one of more of the following portions which may perform one or more acts, sub-acts, etc., desired. One or more of these portions may be implemented as a program executed by a processor thereby causing the processor to become particularly suited for performing in accordance with the one or more portions such as described herein.

The system may include one or more of sensor portion 102, a synchronizer (hereinafter synch) portion 104, a retrieval portion 106, a rules portion 108, a biometric informatics (BI) predictive portion 110, a notification portion 112, an EMR portion 114, an image recognition portion 116, a control portion 124, and an MS 120 which are operably coupled together to enable one or more of which to communicate with each other using a suitable communication connection such as wired and/or wireless communication connection(s). Further, operative acts of portions 104 through 124 may be performed using software (e.g., using applications) and/or hardware. The applications may be stored in a memory of the system. For example, the control portion 124 may be part of the MS 120, may include one or more processors, logic devices, etc., and may control the overall operation of the system.

The sensors 102 may include first through N^{th} sensors (or groups of sensors) such as sensor 102-1 (sensor 1) through 102-N (generally 102-x) which may obtain information related to, for example, physiological indications of a user, environmental conditions (e.g., temperature around the patient, barometric pressure, pollen count, etc.), locations (e.g., of the user), images (e.g., image information), etc.

In accordance with embodiments of the present system, physiological indications may include information related to physiologic activities of a user such as pulse, breathing (e.g., information indicative of breaths per minute (BPM), duration of breath cycles (e.g., inhale, exhale, etc.)), temperature, blood glucose level, physiological pressures (e.g., blood pressure), electrical activity (e.g., EKGs, etc.), chemical levels (e.g., O₂, N₂, CO, etc.), biologic levels (e.g., white or red blood cell count, etc.), presence of pathogens, and/or other information which may be indicative of biological states, functions, levels, activities, etc., of a user and may be sensed by one or more of the corresponding sensors 102-x, such as medical sensors 102-5. In accordance with embodiments of the present system, devices that continuously monitor one or more conditions of the user may operate as the sensor and/or together with one or more other sensors. For example, devices such as halter-monitors that monitor the users heart beat, blood pressure, etc., may operate as one or more of the sensors. Other devices such as Fitbit and others may continuously and/or periodically monitor the user vital information of the body and may be utilized in accordance with embodiment of the present system send the information to the system for use for predicting possible health issues combined with the other sensor data, as sensor input for predicting a condition of the user and/or for retrieving a filtered EMR.

In accordance with embodiments of the present system, environmental conditions (e.g., air quality) may include temperature, humidity, barometric pressure, Oₓ/COₓ/NOₓ levels, chemical and/or biological compounds, contaminants (e.g., pollen, pollutants, dust, etc.), radiation levels, particulate levels, wind speed, ultraviolet (UV) radiation, infrared (IR) radiation levels, etc., and may be sensed by one or more of the corresponding sensors 102-x, such as an air quality sensor 102-3.

In accordance with embodiments of the present system, location information may include information related to geophysical location, azimuth, zones (e.g., inner city, suburbs, west side, east side, etc.), place (e.g., home, school, work, beach, etc.), magnetic orientation, etc., which may be set by the system and/or the user. The geophysical location of the MS 120 of the user may be determined using any suitable method such as global positioning system (GPS), assisted GPS (AGPS), triangulation, network identification, etc.

Image information may include, for example, still images, video images (e.g., a sequence of images of a user), medical images (e.g., magnetic resonance imaging (MRI) images, X-ray images, computed tomography (CT) scans, etc.), lighting conditions (e.g., light levels, etc.), and may be obtained using one or more suitable sensors 102-x. The sensors 102-x may continually output (e.g., by pushing to the system, etc.) sensor information and/or may output sensor information in response to received signals such as a control signal (CON) from, for example, the control portion 124. The sensor information from each sensor 102-x may include meta information related to its context such as an identity of the sensor, a type of sensor information (e.g., sound information, video information, blood glucose level, air quality, etc.), time (e.g., 2:00 am, Jul. 31, 1998, etc.), location (e.g., geophysical location, network address location, etc.), user ID, etc. The sensor information may include processed and/or raw information in analog and/or digital form. Further, one or more of the sensors 102-x may be remotely located from the user (e.g., a web-based air quality sensor, etc.). In accordance with embodiments of the present system, the sensor may be pushed into the system so that relevant medical conditions that might affect the user may be determined.

The context information may have a desired format and may include information related to: type (e.g., video), time, day, date, sensor ID, location, etc. For example, image information from an image sensor 102-2 (e.g., sensor 2) may include contextual information such as (video information, pulse, 10:00:00-10:01:30, 01/01/2000, Sensor 2, home). In a similar manner audio information of a user breathing may include contextual information such as (audio information, user breathing, 11:30:00-11:31:00, 01/01/2000, Sensor 1, downtown NYC). With respect to the location, the location may correspond with a geophysical location, a place such as work, home, municipal location (e.g., NYC, downtown, uptown, inner city, etc.), zones (e.g., work zone, school zone, home zone, etc.), etc., which may be defined or selected by the user and/or the system. Accordingly, when collecting sensor information relating to location and/or environmental condition(s), the system may obtain information from one or more sensors which are located in an area of interest such as a selected location (e.g., west side, east side, etc.).

Further, with respect to the sensors 102-x, one or more of the sensors 102-x may provide different types of information. For example, with regard to various physiological indicators of the user (e.g., pulse, breaths per minute, etc.), associated information may be captured by different sensors and processed in accordance with the type of sensor capturing the sensor information. For example, a user's pulse rate may be determined by processing an image of a user's artery or vein captured by a camera 102-2 of the MS 120 or may be determined by a medical device such as sensor 102-5. Similarly, breaths per minute (BPM) of a user may be determined by analyzing suitable information such as audio information of a user breathing which may be captured by a microphone 102-4 of, for example, an MS 120.

The sensors 102-x may form a part of a network such as, for example, a personal area network (PAN) of the user 105, a local area network (LAN), a wide area network (WAN), a distributed network, a peer-to-peer (P2P) network, and/or may communicate with each other and/or other portions of the present system 100 using any is suitable communication method such as a wired and/or wireless communication method (e.g., the Internet, Bluetooth™, etc.). The sensors 102-x may be stand-alone sensors (e.g., a remote temperature sensor such as a web-based municipal air-quality sensor, a Bluetooth™ enabled MIC, etc.), mobile station sensors (e.g., smart phone sensors such as camera, MIC, temperature sensor, location sensor, etc.), and/or medical equipment sensors (e.g., EKG sensors, etc.).

The control portion 124 may output an acquisition signal to inform/control the synch portion 104 to acquire sensor information at periodic, continuously (e.g., real-time) and/or non-periodic intervals. The acquisition signal may be generated based on, for example, an alarm signal generated by an alarm application (e.g., a breathing analysis processing program, etc.), a calendar application (e.g., at a certain time, day, date, year, etc.), a timer application (e.g., when it is determined that a threshold time has elapsed), an event occurrence application (e.g., when a certain event occurs such as a change of location, network, a call is made, etc.), etc. The alarm signal may also include contextual information such as information related to a type of alarm (e.g., an alarm to acquire breathing information, blood glucose level, air quality at a certain location such as the inner city and suburbs, etc.). Further, the alarm signal may be generated in response to a user's selection (e.g., run breathing test). Thus, when a breathing analysis application generates an alarm, the control portion 124 may signal the synch portion 104 to acquire sensor information from the MIC 102-1 over a one minute interval. To conserve system resources, the control portion 124 may activate and/or request sensor information from various sensors such as the camera Sensor 2 102-2 and/or a remote sensor such as the web-based medical sensors 102-5, and the selected sensors may transmit corresponding information (e.g., sensor) which may be captured by the synch portion 104.

The synch portion 104 may aggregate the sensor information which it receives from the plurality of sensors 102-x and output this information to the retrieval portion 106 as output sensor information for further processing. Accordingly, the synch portion 104 may aggregate a plurality of parallel and/or serially received sensor information into the output sensor information. Further, the synch portion 104 may include context information in the output sensor information.

The retrieval portion 106 may receive the output sensor information (hereinafter received sensor information) from the synch portion 104 and may process it to determine types and/or values of the received sensor information (e.g., temperature, air quality, blood glucose level, image information, audio information, location, etc.) and/or perform acts in accordance with a context of the received sensor information (e.g., perform blood glucose test, breathing analysis, etc.). For example, the retrieval portion may process the received sensor information to determine various medical conditions (e.g., diabetes, apnea, stress levels, allergies, etc.). For example, in accordance with embodiments of the present system, the retrieval portion may include intelligence to analyze and predict possible medical hazards to the user based on the sensor information. In accordance with embodiments of the present system, sensing data may be used as input to the retrieval portion 106 on what parts of the EMR/PHR to make available. External data such as temperature around the patient, barometric pressure, pollen count, and other readings along with location and internal body data from patient sensors may be used as part of the diagnosis/medical record discovery. For example, if a person is having allergies, it could be that the pollen count is high and therefore data from the EMR regarding previous pollen/allergy incidents should be retrieved.

Further, if it is determined that the sensor information includes information that may be determined to require further processing such as audio and/or image information (e.g., a single image and/or a sequence of images, video information, etc.), the retrieval portion 106 may transmit the image information to the image recognition portion 116 where the image information may be processed to, for example, to recognize various features from the image information such as user identity, (e.g., using biometric analysis (e.g., fingerprint, retinal image, etc.), facial analysis, etc.) and/or certain image features (e.g., optically determined pulse rate from a sequence of images of an artery of a user's hand, etc.). Similarly, the image recognition portion 116 may identify audio information and process the audio information to determine information which may be obtained from the processed audio information such as BPM, etc. The image recognition portion 116 may then return the results of the processed image and/or audio information (e.g. user ID, pulse rate, lighting conditions, BPM, etc.) to the retrieval portion 106 for further processing. The retrieval portion 106 may process the results returned from the image recognition portion 116 to determine various medical conditions (MCs) (e.g., diabetes, sleep apnea, stress, etc.) of the user. The retrieval portion 106 may filter the EMR portion 114 for EMR of the identified user of a plurality of users in accordance with the determined MCs of the user.

The EMR portion 114 may store the EMR for a plurality of users in one or more databases (DBs) and may be searched using any suitable search method such as, for example, a SPARQL Protocol and RDF Query Language (SPARQL) search query in the present example. However, other search methods are also envisioned. Accordingly, the retrieval portion 106 may form a query (e.g., a SPARQL query) based upon one or more of determined MCs (e.g., diabetes in the present example), the received sensor information (e.g., blood glucose level, etc.), and/or user ID and transmit this query to the EMR portion 114. A server in the EMR portion 114 may then search its databases for records of the identified user which correspond with the query. Accordingly, the EMR portion 114 may return EMR records (e.g., results of the query) of the user which are mapped to diabetes (e.g., a medical condition) such as blood glucose levels over time, heart condition, blood flow, etc. The EMR records may be mapped to certain conditions by the system and/or the user on a one-to-one basis such as through a table of such mappings stored in the MIM. For example, with regard to diabetes, this medical condition may be mapped to records and/or the records may be organized in accordance with user conditions which may include the aforesaid blood glucose levels over time, heart condition, blood flow, and/or other records which the user and/or the system may select as related to the condition. Similarly, a condition such as sleep apnea may be mapped to, for example, breathing rates, sleep time/duration, blood alcohol level, etc. The conditions may also be mapped to doctors and/or users who may access the records and times, place, etc. where the records may be accessed (e.g., such as through the use of privacy settings). The EMR portion 114 may also update its database to reflect the query.

The retrieval portion 106 may then send the results of the query and/or the received sensor information to the rules portion 108 for further processing. However, it is also envisioned that the query results may be transmitted to a desired MS (or MSs) and/or rendered on a display of the system such as display 122 of the MS 120.

The rules portion 108 may process the query results and/or the received sensor information in accordance with the corresponding rules. The rules may be selected in accordance with the determined MC(s), the ID of the user, and/or the sensor information. For example, in the present example, the selected MC is determined to be diabetes and the user is identified as John Doe, male, age 45. Accordingly, the rules portion 108 may acquire rules corresponding with the MC for a 45 year old male from a rules database which may be stored in a memory of the system. Then, the query results and/or the sensor information may be processed in accordance with the corresponding rules. In the present example, it will be assumed that the receive sensor information includes information indicating an actual blood glucose value of 260 and the rules may include various threshold ranges for various states of diabetes such as a first (moderate), through fourth (severe) ranges of 100-150, 150-200, 200-250, and 250-300, respectively. Accordingly, the BI predict portion 110 may compare the actual blood glucose value (e.g., the sensed value) with the corresponding rules (e.g., blood glucose ranges in the present example) and determine that the corresponding range is 250-300 (e.g., the blood glucose is determined to be greater than 250 and less than 300) and determine that the diabetic condition corresponds with the fourth range (e.g., is severe). Then, the results of the determination(s), comparison(s), etc., (hereinafter determinations) performed in accordance with the rules may be output to the BI predict portion 110.

The BI prediction portion 110 may process the results of the determination(s), comparisons, etc. from the rules portion 108 and/or the received sensor information in accordance with model/prediction information and determine corresponding models and/or predictions. Accordingly, the BI predict portion 110 may access the model/prediction information related to the selected MC (of a plurality of conditions) from a memory of the system and compare the results of the determination(s) from the rules portion 108 and/or the sensor information with the model/prediction information and form a corresponding model/prediction. For example, assuming that the EMR obtained as a result of the query of the user indicates that the user has a glucose spike which peaks at about 300 each day at about the same time (e.g., 2:30 pm) when untreated and that the current time is about 2:30 (corresponding with the latest sensor test) and that the user's type of diabetes is type I, the BI prediction portion 110 may form a model/prediction which assumes that the user's blood glucose level will peak at about 300 in about ½ an hour and recommend that the user take an appropriate action such as consume (e.g., by injection, inhalation, etc.) an amount of insulin calculated for the predicted blood glucose level (e.g., 300) in about 10 minutes. Then, the BI prediction portion 110 may output the model/prediction to the notification portion 112. Other user conditions such as allergies of the user may form a portion of a model/prediction that, for example, due to high pollen counts in the area around the user as determined by environmental sensors, the user is likely to experience an allergic reaction and the user through the BI prediction portion 110 may be notified accordingly, such as by the notification portion 112, the user may be notified to avoid an area or may be notified to take a medication to counteract the expected allergic reaction prior to the user experiencing the allergic reaction. Accordingly, the user may take an appropriate action which may be as modeled by the system to avoid potential dangers, etc.

The notification portion 112 may output the query results, the received sensor information, and/or the model prediction information on a user interface (UI) such as a display 122 of the MS 120. Further, the notification portion 112 may determine whether a user has selected to transmit certain information such as the query results, the received sensor information, and/or the model prediction information, to a desired address (e.g., an email address, a short message service (SMS) address, an internet protocol (IP) address, etc.). Accordingly, the notification portion 112 may access information related to the user such as user settings and transmit selected information to one or more addresses (e.g., email, etc.) and/or the MS 120 in accordance with the settings.

The control portion 124 may be operative to update the EMR related to the user with current sensor information (e.g., corresponding with the received sensor information, etc.), current diagnosed medical conditions, user settings, models/predictions, etc., for later use.

An exemplary process of an identified user “SAM SMITH” who is assumed to travel often with an MS which has an application which can analyze the breathing activity of a user to determine associated information such as BPM, stress levels, and/or corresponding medical conditions will now be described. Further, it is assumed that an EMR memory of the system stores EMR (e.g. EMR records) for a plurality of users and which may be updated in accordance with sensor information (e.g., obtained from a plurality of sensors) at periodic intervals such as every 5 minutes, etc.

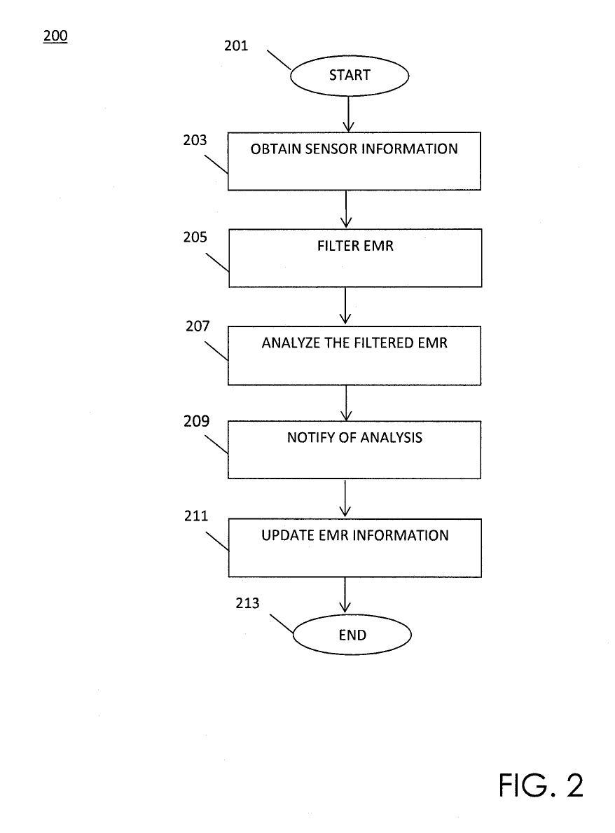

FIG. 2 shows a flow diagram that illustrates a process 200 in accordance with an embodiment of the present system. The process 200 may be performed using one or more computers communicating over a network. The process 200 can include one of more of the following acts. In operation, the process may start during act 201 and then proceed to act 203.

During act 203, the MS of the user (e.g., SAM) may obtain sensor information corresponding to, for example, the user's location (e.g., from environmental sensors) and/or physiological functions of the user such as the user's breathing characteristics of the user. The sensor information corresponding to the location of the user may be processed to determine a location of the user (e.g., downtown, at School, etc.) and the sensor information corresponding with the user's physiological functions may be processed to determine, for example, associate information such as BPM, duration of parts of breathing cycle (e.g., average inhalation cycle 5 seconds, average exhalation cycle 7 seconds), etc.), stress levels, etc. Accordingly, the process may determine any MCs of the user such as allergies, hypertension, hypotension, etc. Accordingly, in the present example, it is assumed that the determined MCs of the user may correspond with, for example, a high stress level. The sensor information corresponding with the user's location may be obtained, for example, using GPS information and the sensor information corresponding with the user's breathing characteristics may be obtained from a microphone which may record the audio sounds emitted when the user breaths. Methods to analyze breathing information of a user are disclosed through the Internet at “breathresearch.com.” After completing act 203, the process may continue to act 205.

During act 205, the process may filter EMR records in an EMR database to obtain EMR records which are determined to correspond with the sensor information (e.g., breathing rates, as temperature around the patient, barometric pressure, pollen count, etc.), the user (e.g., user ID), and/or any detected MCs, from an EMR memory of the system. Accordingly, in the present example where the sensor information may include information related to breathing characteristics of the user, the EMR memory may return filtered EMR including EMR records relating to associated information such as one or more of asthmatic conditions, allergies, blood pressure, stress levels, immunizations, etc., that may be mapped to the corresponding sensor information and/or MCs. The process may associate information based upon predefined associations and/or learned associations (e.g., which may be learned by the process using intelligent processing methods such as neural processing methods, adaptive processing methods, etc.). For example, if a user has a history of allergies, it could be that the pollen count is high and therefore data from the EMR regarding previous pollen/allergy incidents should be revealed. After completing act 205, the process may continue to act 207.

During act 207, the process may analyze the filtered EMR records by, for example, comparing one or more of (current) sensor information, detected medical conditions, etc. For example, the system may determine that the user does not suffer from high blood pressure, and has been immunized from for example, the flu. However, the system may determine from the sensor information that the user is in the inner city and may obtain air quality information in and around the city from a plurality of a web-based sensors. The system may then further analyze the filtered EMR of the user and determine that when the air quality is below a certain threshold, the user typically (e.g., above 80% of the time or some other threshold) suffers from asthmatic attacks (e.g., a medical condition) and/or allergies. Accordingly, the system may then determine locations in the user's vicinity (or some other area or radius) which have air quality that is determined to be below (e.g., less than) the threshold value and in which the user is likely to suffer an asthmatic attack, allergies, or just generally have difficulties with breathing and/or locations in the user's vicinity which have air quality which is determined to be above (e.g., greater than) the threshold value (or another threshold value). As the system processes information, it may search for EMR of the user which may be helpful for further processing. For example, locations, times, etc. during which the user suffered asthmatic attacks, allergies, etc. Then, the system may determine one or more appropriate actions such as healthier alternatives such as to suggest a route through a part of city to avoid the breathing difficulties, taking medication prior to an onset of a condition (e.g., difficulty breathing, allergy, etc.) etc. After completing act 207, the process may continue to act 209.

During act 209, the process may notify the user in accordance with the analysis of act 207 and inform the user of most appropriate actions. Accordingly, for example, the process may inform the user that the user is physically reacting to the quality of the air and may suffer from an imminent asthmatic attack in the current location (e.g., in the inner city). Accordingly the system may recommend most appropriate actions such as taking a medication to alleviate an expected response from the user, recommending locations which are determined to have better air quality such as outdoor locations which have an air quality (e.g., obtained via web-based air quality sensors) that is determined to be greater than certain thresholds and/or indoor areas (e.g., malls, etc.) which may have filtered air, etc. Depending on the determined condition and/or risk to the user, one or more appropriate actions may be suggested to the user. In accordance with embodiments of the present system, the notification may take a form of an ordered list. For example, with regard to the risk of an asthma attack, the ordered list may first recommend avoiding an area and if this is not practical for the user, the next recommendation may be to take medication and/or to bring medication along to alleviate or reduce the risk of the attack. The notification may be displayed on a MS of the user and/or may be transmitted to one or more selected addresses (e.g., email addresses, IP addresses, a medical service provider, an EMR database, etc.) which may be selected by the system and/or the user and stored in a memory of the system. After completing act 209, the process may continue to act 211.

During act 211, the process may update information related to the user such as in the EMR database. The process may also update geophysical information such as air quality information for one or more areas for a certain time, etc. After completing act 211, the process may continue to act 213 where it ends.

Accordingly, the process may aggregate information and use intelligent systems and/or processing to determine one or more most appropriate actions in accordance with sensor information and the EMR of the user. Further, the system may also analyze sensor information from the user, such as the breathing patterns of the user and notify the user of any abnormalities based upon corresponding meta data information and/or from the filtered EMR that may be relevant to breathing and other associated medical conditions of the user.

Further, depending upon the information that is sensed by the sensors, the sensor information may be pushed directly to an EMR record of the user. For example, blood pressure, glucose levels, etc., of the user captured by body sensors may be pushed to an EMR portion where they may be used to update EMR records of the user. Moreover, the system may have different access restrictions set (e.g., privacy settings) for the user (e.g., a patient), medical service providers (e.g., doctors of the patient), etc., to enable access to filtered EMR records of the user.

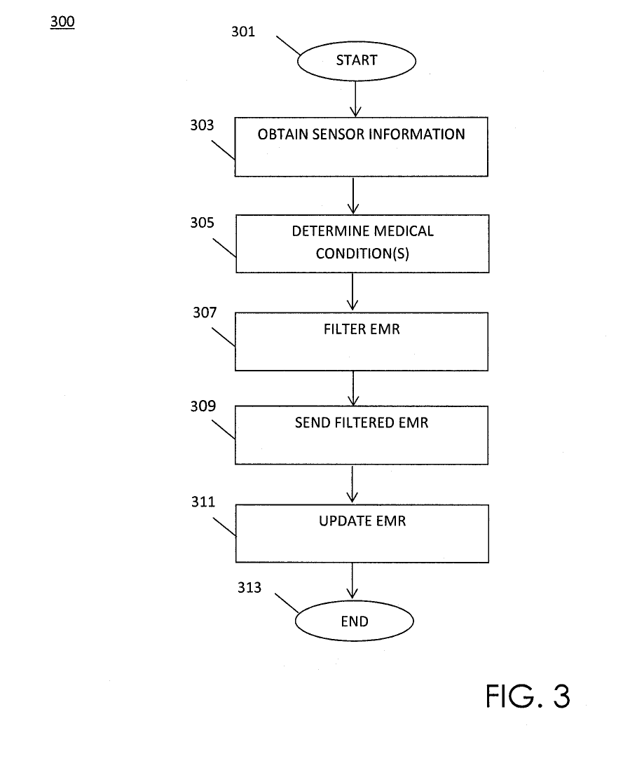

FIG. 3 shows a flow diagram that illustrates a process 300 in accordance with embodiments of the present system. In accordance with the embodiments of the present system shown in FIG. 3, a user's filtered EMR may be retrieved based on a condition (e.g., difficulty breathing) of the user. The process 300 may be performed using one or more computers communicating over a network. The process 300 can include one of more of the following acts. In operation, the process may start during act 301 and then proceed to act 303.

During act 303, the process may obtain sensor information related to an identified user such as blood glucose level, blood pressure, audio information, etc. The audio information for example may have been collected by a microphone which detects sound in the vicinity of the user's throat which may be processed to determine BPM and duration of portions of the breathing cycles such as inhalation and/or exhalation times etc. After completing act 303, the process may continue to act 305.

During act 305, the process may determine one or more medical conditions of the user based upon an analysis of the sensor information. For example, the process may determine that the user is diabetic based upon an analysis of the blood glucose levels (e.g., blood glucose level is greater than a threshold level). In a similar fashion, the system may determine that the user is highly stressed based upon a comparative analysis of the BPM with one or more threshold values. For example, the process may compare the BPM with first and second threshold values or value ranges. Accordingly, if the BPM is found to be greater than a first threshold value and less than a second threshold value, the process may determine a corresponding stress level (e.g., highly stressed as opposed to no stress, moderate stress, etc.). After completing act 305, the process may continue to act 307.

During act 307, the process may filter the EMR for EMR records which are associated related to (e.g., mapped to) the determined medical conditions and/or sensor information and obtain corresponding filtered EMR. For example, in the present example, the filtered EMR may include information associated with medical conditions determined during at 305 and/or sensor information such as high stress, high blood pressure, diabetic, BPM, etc. After completing act 307, the process may continue to act 309.

During act 309, the process may send the filtered EMR to one or more addresses (e.g., email addresses, IP addresses), displays (e.g., a display of the MS of the user), etc. After completing act 309, the process may continue to act 311, for example in accordance with privacy settings, such as related to the user and/or the EMR.

During act 311, the process may update the EMR related to the user in accordance with the sensor information and/or the determined conditions and continue to act 313, where it ends.

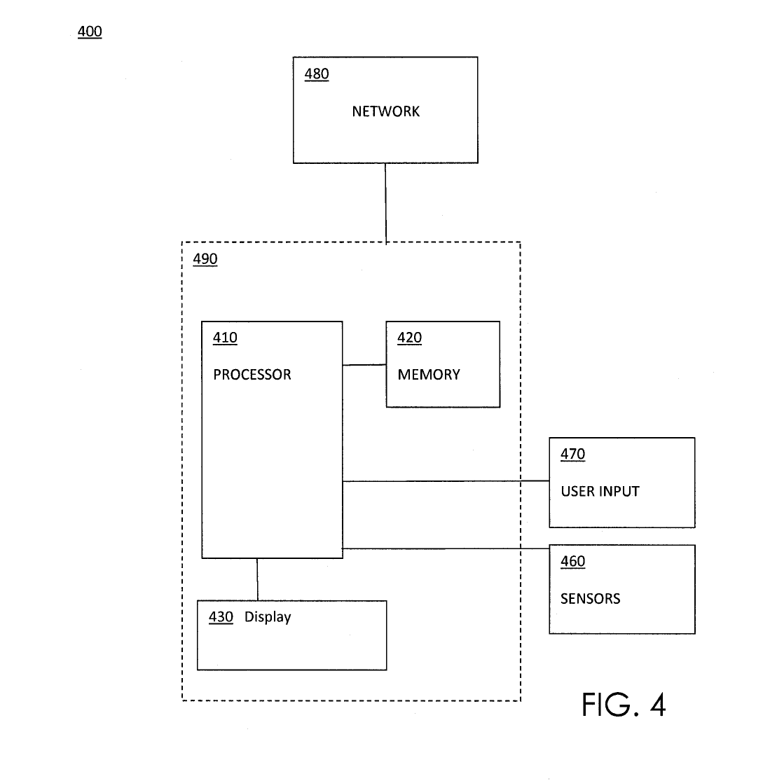

FIG. 4 shows a portion of a system 400 (e.g., MS, server, database, etc.) in accordance with embodiments of the present system. For example, a portion of the present system may include a processor 410 operationally coupled to a memory 420, a display 430, sensors 460, and a user input portion 470. The memory 420 may be any type of device for storing application data as well as other data related to the described operation. The application data and other data are received by the processor 410 for configuring (e.g., programming) the processor 410 to perform operation acts in accordance with the present system. The processor 410 so configured becomes a special purpose machine particularly suited for performing in accordance with the present system.

The operation acts may include requesting, providing, and/or rendering of content (e.g., a filtered EMR). The user input portion 470 may include a keyboard, mouse, trackball or other device, including touch-sensitive displays, which may be stand alone or be a part of a system, such as part of an MS or other device for communicating with the processor 410 via any operable link. The user input portion 470 may be operable for interacting with the processor 410 including enabling interaction within a UI as described herein. Clearly the processor 410, the memory 420, display 430, sensors 460, and/or user input device 470 may all or partly be a portion of a MS, computer system and/or other device such as a client and/or server as described herein.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 420 or other memory coupled to the processor 410.

The program and/or program portions contained in the memory 420 configure the processor 410 to implement the methods, operational acts, and functions disclosed herein. The memories may be distributed, for example between the clients and/or servers, or local, and the processor 410, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessible by the processor 410. With this definition, information accessible through a network is still within the memory, for instance, because the processor 410 may retrieve the information from the network for operation in accordance with the present system.

The processor 410 is operable for providing control signals and/or performing operations in response to input signals from the user input portion 470, the sensors 460, as well as in response to other devices of a network and executing instructions stored in the memory 420. The processor 410 may be an application-specific or general-use integrated circuit(s). Further, the processor 410 may be a dedicated processor for performing in accordance with the present system or may be a general-purpose processor wherein only one of many functions operates for performing in accordance with the present system. The processor 410 may operate utilizing a program portion, multiple program segments, and/or may be a hardware device utilizing a dedicated or multi-purpose integrated circuit.

The sensors 470 may include one or more sensors such as medical sensors (e.g., blood pressure, blood glucose levels, blood oxygen level, blood carbon dioxide level, conductance (e.g., skin conductance), etc.), air quality sensors (e.g., particulate levels, ozone levels, carbon monoxide levels, carbon dioxide levels, chemical sensors, biological sensors, pathogen sensors, etc.), temperature sensors, microphones (e.g., to capture audio information), image capture devices (e.g., to capture an image, a sequence of images, video information, etc.), etc. The sensors 470 may include local (e.g., mounted on an MS, etc.) and/or remote sensors (e.g., web-based sensors, etc.) and may provide corresponding sensor information.

Accordingly, the present system may include one or more sensors that may be in contact with, or external to, a body of a user. The system may store the EMR for one or more users in a memory of the system. The system may use bio-informatics (BI) for intelligence, as well as predictive analytics and/or modeling methods to determine medical conditions, possible discomfort, and/or calculate information that can be helpful for the user to take an appropriate action (e.g., avoid downtown city until 10:00 pm due to poor air quality) based upon various information processed by the system. The EMR may include a complete summary of the patient including the personal details (e.g., user name, address, contact information, gender, date of birth, employer information, etc.), immunizations, conditions, history including of hospitalizations, allergies, drug sensitivities, medications, immunization, doctor visits, medical devices, family member histories, vital signs, etc., and may be accessed in accordance with the sensory information that may be contextual in nature depending on the individual's activity at a given time and/or information related to medical conditions and associate this information in real time to the other entities within the EMR to access desired EMR that may be useful to the user and/or to professionals such as doctors treating the user. For example, in accordance with embodiments of the present system, real time data sensor information may be associated with heterogeneous data from various sensors, EMR and/or other personal data that is available to the user. The data may be associated with social networking sites like Facebook/Twitter and/or other systems to automate the process of updating the real time status of the user. The user typically has full control of what information and to whom the data will be shared, for example based on privacy settings. In accordance with embodiments of the present system, other entities may also involve non-medical information which is available to the public (e.g., Wikipedia) to gain contextual knowledge of the user by combining the contextual information, the data from real time sensors (e.g., environmental sensors), etc., to help the user to take appropriate action.

Further variations of the present system would readily occur to a person of ordinary skill in the art and are encompassed by the following claims. Through operation of the present system, a virtual environment solicitation is provided to a user to enable simple immersion into a virtual environment and its objects.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions (e.g., sub-portions) unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

1. A method of retrieving electronic medical record (EMR) information, the method controlled by one or more controllers and comprising acts of:
obtaining sensor information corresponding to one or more physiologic indications of a user;
identifying a medical condition of the user based upon the sensor information with the one or more controllers;
filtering electronic medical record (EMR) information of the user based upon the identified medical condition of the user, the EMR comprising a plurality of electronic medical records of the user with the one or more controllers; and
providing the filtered EMR of the user.

2. The method of claim 1, further comprising an act of updating the EMR in accordance with the sensor information.

3. The method of claim 1, further comprising acts of:
determining an address of one or more recipients for the filtered EMR; and
transmitting the filtered EMR to the one or more recipients.

4. The method of claim 1, further comprising an act of obtaining other sensor information related to one or more of image information, location information, and environmental information.

5. The method of claim 4, further comprising an act of suggesting an action to the user in accordance with the other sensor information and one or more of the determined medical condition and the filtered EMR.

6. The method of claim 1, further comprising acts of:
identifying the user based upon the image information; and
accessing the EMR in accordance with the identification of the user.

7. A system to retrieve electronic medical records (EMR) information, the system comprising:
a processor portion which:
obtains sensor information corresponding to one or more physiologic indications of a user;
identifies a medical condition of the user based upon the sensor information;
filters electronic medical record (EMR) information of the user based upon the identified medical condition of the user, the EMR comprising a plurality of electronic medical records of the user; and
provides the filtered EMR of the user.

8. The system of claim 7, wherein the processing portion further updates the EMR in accordance with the sensor information.

9. The system of claim 7, wherein the processing portion:
determines an address of one or more recipients for the filtered EMR; and
transmits the filtered EMR to the one or more recipients.

10. The system of claim 7, wherein the processing portion obtains other sensor information related to one or more of image information, location information, and environmental information.

11. The system of claim 10, wherein the processing portion determines an appropriate action in accordance with the other sensor information and one or more of the determined medical condition and the filtered EMR, and informs the user of the appropriate action.

12. The system of claim 7, wherein the processing portion further:
identifies the user based upon the image information; and
accesses the EMR in accordance with the identification of the user.

13. A non-transitory computer readable memory medium comprising a computer program stored thereon, the computer program configured to retrieve electronic medical record (EMR) information when executed by a processor, the computer program comprising a program portion configured to:
configure the processor to obtain sensor information corresponding to one or more physiologic indications of a user;
configure the processor to identify a medical condition of the user based upon the sensor information;
configure the processor to filter electronic medical record (EMR) information of the user based upon the identified medical condition of the user, the EMR comprising a plurality of electronic medical records of the user; and
configure the processor to provide the filtered EMR of the user.

14. The non-transitory computer readable memory medium of claim 13, wherein the program portion is further configured to update the EMR in accordance with the sensor information.

15. The non-transitory computer readable memory medium of claim 13, wherein program portion is further configured to:
determine an address of one or more recipients for the filtered EMR; and
transmit the filtered EMR to the one or more recipients.

16. The non-transitory computer readable memory medium of claim 13, wherein program portion is further configured to obtain other sensor information related to one or more of image information, location information, and environmental information.

17. The non-transitory computer readable memory medium of claim 16, wherein program portion is further configured to determine an appropriate action in accordance with the other sensor information and one or more of the determined medical condition and the filtered EMR, and informs the user of the appropriate action.

18. The non-transitory computer readable memory medium of claim 13, wherein program portion is further configured to:
identify the user based upon the image information; and
access the EMR in accordance with the identification of the user.

19. A server to retrieve electronic medical records (EMR) information, the system comprising:
a processor portion which:
obtains sensor information corresponding to one or more physiologic indications of a user;
identifies a medical condition of the user based upon the sensor information;
filters electronic medical record (EMR) information of the user based upon the identified medical condition of the user, the EMR comprising a plurality of electronic medical records of the user; and
provides the filtered EMR of the user.
